(19) United States
(12) Patent Application Publication
(10) Pub. No.: US 2012/0134767 A1
(43) Pub. Date: May 31, 2012

(54) BOOKBINDING APPARATUS AND IMAGE FORMING SYSTEM

(75) Inventor: Tsuyoshi TSUCHIYA, Tokyo (JP)

(73) Assignee: KONICA MINOLTA BUSINESS TECHNOLOGIES, INC., Tokyo (JP)

(21) Appl. No.: 13/302,290

(22) Filed: Nov. 22, 2011

(30) Foreign Application Priority Data
Nov. 30, 2010 (JP) JP2010-266175

(51) Int. Cl. B42C 9/00

(52) U.S. Cl. 412/37

(57) ABSTRACT

A bookbinding apparatus including an adhesive reservoir for storing melted adhesive, a heating member for heating and melting the adhesive stored in the adhesive reservoir, an adhesive coating member for coating a sheet bundle with the adhesive stored in the adhesive reservoir, and an adhesive deterioration detecting device for detecting a state of deterioration of the melted adhesive.

This application is based on Japanese Patent Application No. 2010-266175 filed on Nov. 30, 2010 with Japanese Patent Office, the entire content of which is hereby incorporated by reference.

### BACKGROUND OF THE INVENTION

The present invention relates to a bookbinding apparatus for binding a bundle of sheets by applying an adhesive to the spine of the sheet bundle, and an image forming system provided with the apparatus.

There has been widespread use of an image forming system as an on-demand printer system that produces a booklet by forming an image on sheets of paper by using an image forming apparatus, and binding these plural sheets using a bookbinding apparatus as a post processing apparatus. In such an image forming system, a bookbinding apparatus provided with an adhesive coating device is often used so that an adhesive may be applied to the spine of a bundle of the sheets having an image recorded thereon and these sheets may be subjected to a binding operation to produce a booklet. The hot-melt adhesive normally used in the adhesive coating device of such a bookbinding apparatus is a solid pellet at normal temperature, and is melted and liquefied by being heated in an adhesive reservoir of the adhesive coating device, and then is used for coating.

The bookbinding apparatus of the image forming system is placed in the inactive state when the entire system is put in the standby mode. Further, this apparatus is normally placed in the inactive state when an operation other than bookbinding is performed, although the entire system is working.

In one of the techniques developed in recent years, when the bookbinding apparatus is put in the inactive state, the heater for heating the adhesive is turned off and the adhesive temperature is kept below the coating temperature. This technique is effective in saving electricity, minimizing offensive smells and preventing an adhesive from being degraded. To be more specific, when the adhesive is placed in a high temperature atmosphere for a long time, discoloration or deterioration in bonding strength will occur and the adhesive is subjected to progress of deterioration. This problem can be solved by reducing the temperature of the adhesive.

It is disclosed that a bookbinding apparatus provided with an agitating member in the adhesive reservoir for keeping the viscosity and temperature of the adhesive constant in the adhesive reservoir, in addition to reducing the adhesive temperature to prevent possible deterioration of the adhesive, for example, in the Unexamined Japanese Patent Application Publication No. 2009-119771. According to the Unexamined Japanese Patent Application Publication No. 2009-119771, uniform viscosity and temperature of the adhesive in the adhesive reservoir is provided. Thus, the performance in coating the sheet bundle is improved and the adhesive temperature is reduced, with the result that adhesive deterioration can be minimized.

### SUMMARY

To achieve at least one of the above mentioned objects, a bookbinding apparatus and an image forming system reflecting one aspect of the present invention are as follows.

1. A bookbinding apparatus including an adhesive reservoir for storing melted adhesive, a heating member for heating and melting the adhesive stored in the adhesive reservoir, an adhesive coating member for coating a sheet bundle with the adhesive stored in the adhesive reservoir, and an adhesive deterioration detecting device for detecting a state of deterioration of the melted adhesive.

2. An image forming system including an image forming apparatus for forming an image on a sheet, and the bookbinding apparatus described in the above Item 1 for bookbinding by applying adhesive on a bundle of sheets each of which has an image formed thereon by the image forming apparatus.

### BRIEF DESCRIPTION OF THE DRAWINGS

FIG. 1 is an overall schematic diagram representing an image forming system provided with an image forming apparatus, bookbinding apparatus and sheet ejection apparatus.

FIG. 2 is a cross sectional view representing the overall structure of the bookbinding apparatus B in an embodiment of the present invention.

FIG. 3 is a schematic cross sectional view showing the structure and operation in the first embodiment of the adhesive coating device 50 of the present invention.

FIG. 4 is a schematic cross sectional view showing the structure and operation in the second embodiment of the adhesive coating device 50 of the present invention.

FIG. 5 is a schematic cross sectional view showing the structure and operation in the third embodiment of the adhesive coating device 50 of the present invention.

FIG. 6 is a schematic side view showing the positional relationship between the adhesive coating device 50 and holding device 41, and the operation thereof.

FIG. 7 is a perspective view of FIG. 6.

FIG. 8 is a perspective view showing the structure and operation of the elevation drive of the holding device 41.

FIG. 9 is a schematic cross sectional view of a bookbinding apparatus B for describing the structure and operation of bonding the cover sheet K to the sheet bundle Sa.

FIGS. 10a-10d are cross sectional views of the cover-sheet outfitting device 80 and sheet bundle Sa showing how to fold the cover sheet K.

FIGS. 11a-11b show perspective views of a sheet bundle Sa with the cover sheet K bonded thereto and a booklet Sb produced by wrapping folding of the cover sheet K on the sheet bundle Sa.

FIGS. 12a-12c are front views showing the process of ejecting the booklet Sb consisting of a sheet bundle Sa and cover sheet K.

FIG. 13 is a block diagram relating to the control system of the control device 9A to control the operation of the bookbinding apparatus B in the embodiment of the present invention.

### DETAILED DESCRIPTION OF THE PREFERRED EMBODIMENT

Next, the present invention will be described referring to the embodiments illustrated, however the present invention is not limited to the embodiments.

### [Image Forming System]

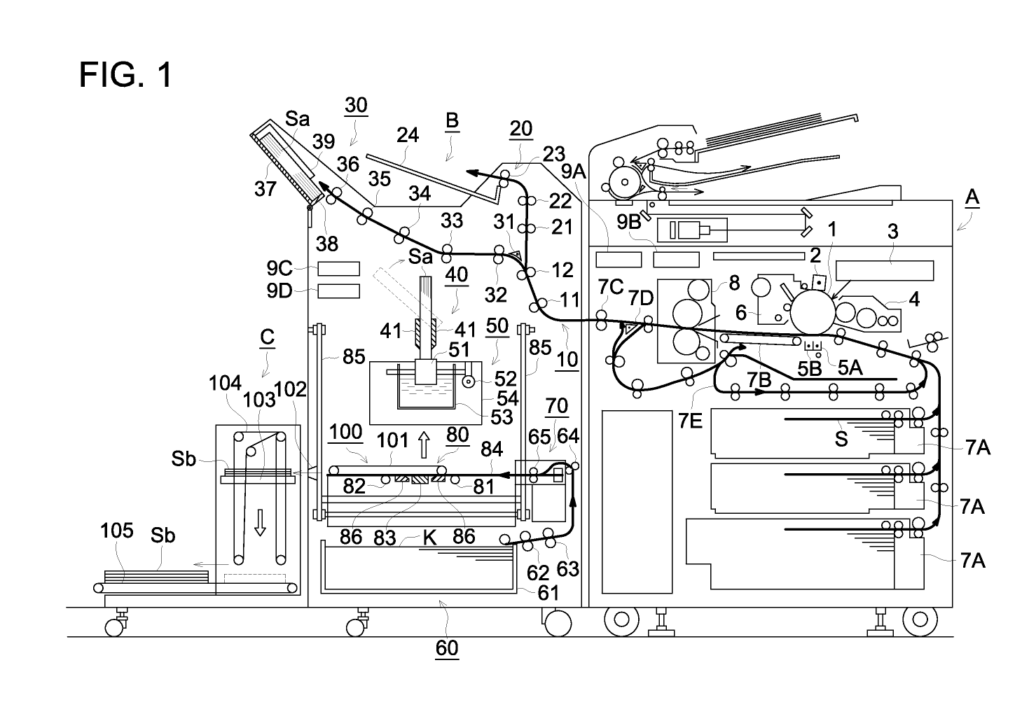

FIG. 1 is an entire structure diagram of an image forming system equipped with an image forming apparatus A, bookbinding apparatus B and sheet ejection apparatus C.

### [Image Forming Apparatus]

The image forming apparatus A has an image forming unit where a charging unit 2, image exposure unit 3, developing unit 4, transfer unit 5A, neutralizing unit 5B and cleaning unit 6 are arranged around a rotary image carrier 1. In the image forming unit, exposure scanning by a laser beam of the image exposure unit 3 based on image data obtained by reading from a document is conducted to form a latent image after a surface of the image carrier 1 is charged by the charging unit 2, and the latent image is developed by the developing unit 4, and a toner image is formed on a surface of the image carrier 1.

A sheet S fed from a sheet storing section 7A is transported to a transfer position. In the transfer position, the toner image is transferred onto the sheet S by the transfer unit 5A. After that, charges on the reverse side of the sheet S is eliminated by the neutralizing unit 5B and the sheet S is separated from the image carrier 1 to be transported by a transportation section 7B, and then, is heated for fixing by a fixing unit 8 to be ejected from a sheet ejection roller 7C.

When forming images on both sides of sheet, the sheet S subjected to fixing is diverged downward from an ordinary sheet ejection path by a transportation path changeover device 7D, then, is reversed upside down through a switchback movement in a reversing transportation section 7E, and passes through the image forming section again so that an image is found on the back of the sheet 5, and is ejected out of the apparatus from the sheet ejection roller 7C through the fixing unit 8. The sheet S ejected from the sheet ejection roller 7C is fed into the bookbinding apparatus B.

With respect to the surface of the image carrier 1 after image processing, developing agents remaining on the surface are removed by a cleaning unit 6 so that the image carrier 1 turns out to be ready for the succeeding image forming.

The image forming apparatus A is provided with a control device 9A and operation section 9B. The operation section 9B also serving as a warning device is used to input operation instructions to various portions of the image forming apparatus A and to display warnings and other information. Further, the operation section 9B is also used to input sheet information such as paper size and bookbinding instructions to the bookbinding apparatus B, and to display warnings and other information. The control device 9A of the image forming apparatus A controls operations of various portions of the image forming apparatus A. Further, the control device 9A controls the operations of various portions of the bookbinding apparatus B through a bookbinding apparatus control device 9C.

### [Bookbinding Apparatus]

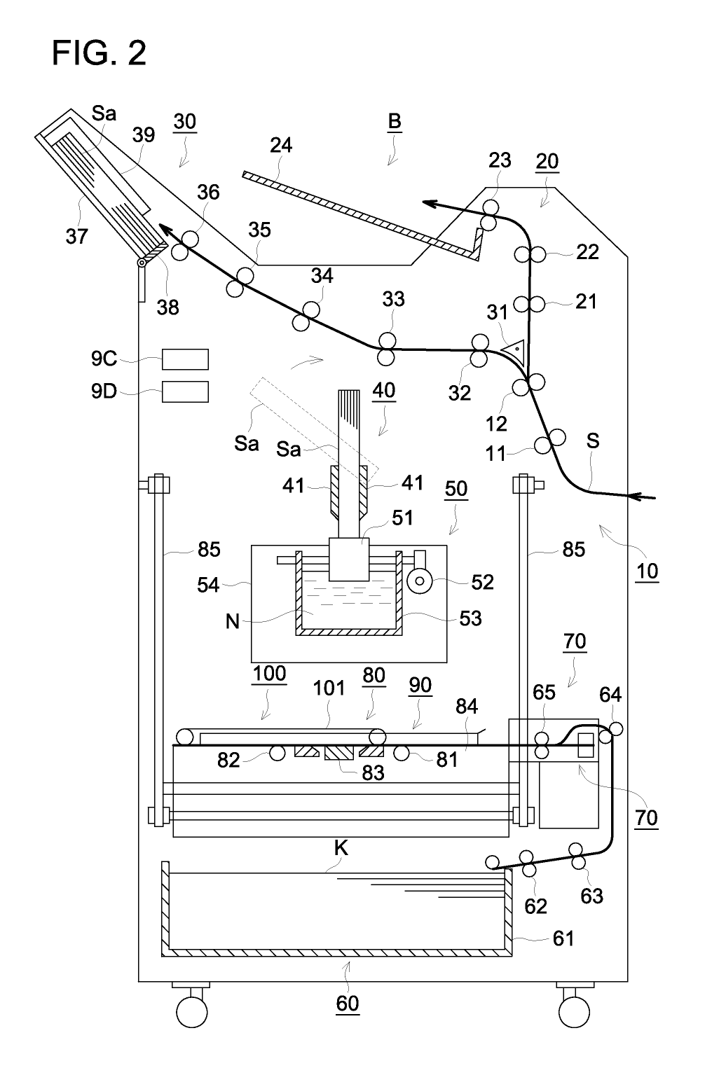

FIG. 2 is a sectional view showing an overall structure of the bookbinding apparatus B relating to an embodiment of the invention.

The bookbinding apparatus B is composed of a sheet introduction unit 10, sheet ejection unit 20, sheet bundle loading unit 30, sheet bundle transportation unit 40, adhesive coating device 50, cover-sheet supply unit 60, cover-sheet trimming device 70, cover-sheet outfitting device 80 (wrapping-bookbinding unit), alignment device 90 and booklet ejection unit 100. The respective units are arranged nearly longitudinally and vertically in the main body of the bookbinding apparatus.

The sheet S that has been introduced into the sheet introduction unit 10 is interposed between inlet rollers 11 and 12 to be transported, and is diverged by a transportation path changeover device 31 to be conveyed to either one of the sheet ejection unit 20 and the sheet bundle loading unit 30.

When the sheet transportation to the sheet ejection unit 20 is established, the transportation path changeover device 31 closes a transportation path leading to the sheet bundle loading unit 30, and opens a transportation path leading to the sheet ejection unit 20. A sheet S introduced into a transportation path leading to the sheet ejection unit 20 is interposed between transporting rollers 21 and 22 to be transported upward, and is ejected by sheet ejection roller 23 and housed in a stationary sheet ejection tray 24 located at the uppermost portion of the apparatus. On the stationary sheet ejection tray 24, the sheet S ejected from the image forming apparatus A is directly received, and about a maximum of 200 sheets can be stacked thereon in this embodiment for example.

When the sheet transportation to the sheet bundle loading unit 30 is established, the sheet S diverged to the downstream side in the sheet transportation direction in the left side in the drawing by a transportation path changeover device 31 is interposed between transporting rollers 32, 33, 34, 35 and 36 to be housed at the prescribed position of the sheet bundle loading unit 30 and to be stacked thereon in succession, thus, a sheet bundle Sa formed by a prescribed number of sheets S is formed based on input of the set number of image forming per one job. The sheet bundle loading unit 30 is composed of a sheet loading table 37 that is arranged obliquely, a movable sheet trailing edge positioning member 38 and sheet width aligning member 39 that aligns sheets in the sheet width direction.

The sheet bundle Sa composed of a prescribed number of sheets S stacked and aligned on the sheet loading table 37 of the sheet bundle loading unit 30 is transported downward obliquely by an unillustrated pushing-out device. After that, the sheet bundle Sa is held by a holding device 41 of the sheet bundle transportation unit 40, and a sheet trailing edge positioning member 38 retreats to under the sheet loading table 37 by being turned by unillustrated drive unit. The holding device 41 holding the sheet bundle Sa moves downward obliquely as shown by the broken line in the drawing and then turns to keep the upright position so that one side edge of the sheet bundle Sa to be subjected to adhesive coating (spine portion) may face downward, to be stopped at the prescribed position.

An adhesive coating device 50 is composed of an adhesive coating member (hereinafter also called a adhesive coating roller) 51, rotating device 52 for rotational driving of the adhesive coating roller 51, adhesive container 53 that contains adhesive paste, movable member 54 that support the adhesive container 53 movably, and an unillustrated drive unit that reciprocates the movable member 54. The movable member 54 is reciprocated between the rear surface side of the bookbinding apparatus B which is the initial position and the front surface side which is the adhesive coating position.

The cover sheet K housed in a sheet feeding tray 61 of a cover-sheet supply unit 60 is separated and fed by a sheet feeding unit 62, interposed between transporting rollers 63, 64 and 65, and transported to a cover-sheet outfitting device 80. Then the cover sheet K is aligned by the alignment device 90 and conveyed to the cover-sheet trimming device 70 through a switchback. The cover-sheet trimming device 70 integrally formed on the right side of an illustrated cover-sheet outfitting device 80 (to be described later) above the upper side of the cover-sheet supply device 60 is used to trim the length of a cover sheet K to a predetermined value in the direction of conveyance. The cover-sheet trimming device 70 is a roller cutter unit made of a rotary blade and stationary blade. The rotary blade rotates by sliding along the stationary blade, and cuts the cover sheet K in the width direction of the cover sheet. The waste of the cover sheet K having been cut drops and is stored in the chip box (no reference No.). The length of the cover sheet K having been trimmed corresponds to the value obtained by adding the width dimension of the spine portion of the bundle of sheets Sa to the length of two sheets S in the direction of conveyance.

In the operation section 9B of the image forming apparatus A, when the sheet size, number of sheets and the thickness of the sheets have been selected or detected, the control device 9A sets a predetermined length of the cover sheet K having been trimmed. The length of the cover sheet K before trimming is determined in response to the maximum number of the sheets.

The cover-sheet outfitting device 80 is composed of transporting rollers 81 and 82, pressing member 83 that brings the cover sheet K into pressure contact with an adhesive-coated surface of sheet bundle Sa, the movable casing 84 that supports the transporting rollers 81 and 82 and the pressing member 83 and belts 85 as an elevating unit that makes it possible for the movable casing 84 to move up and down vertically. The transporting rollers 81 and 82 receive the cover sheet K supplied from the cover-sheet supply unit 60 to transport it and to stop it at the prescribed position.

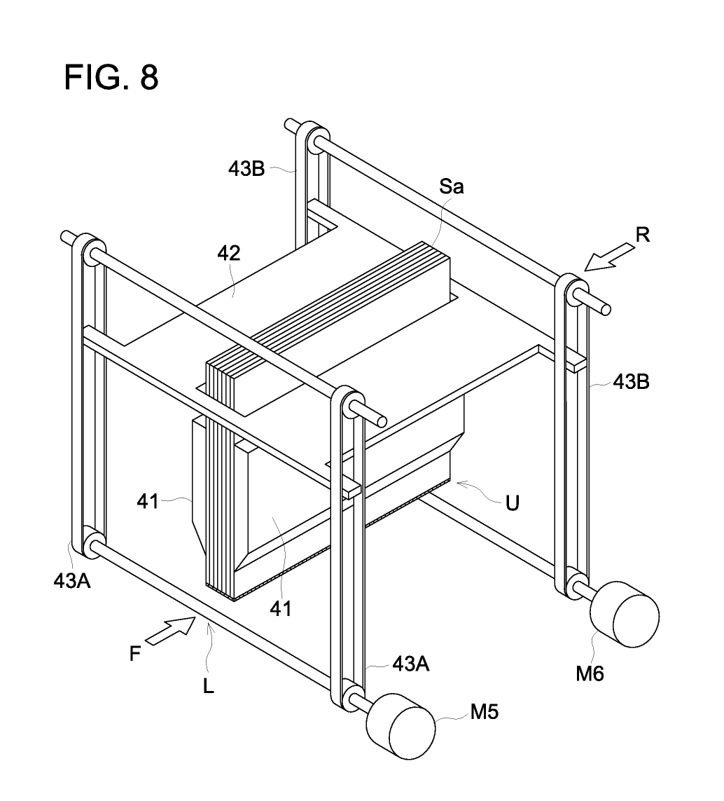

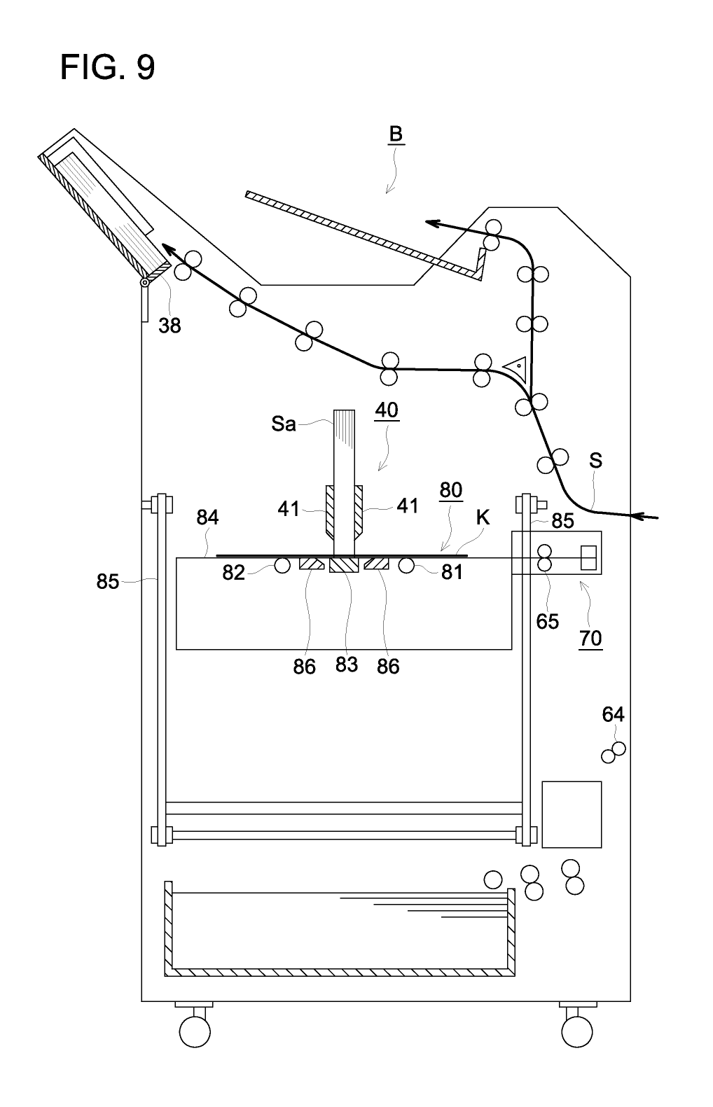

The movable casing 84 is moved to a raised position by turning a belt 85 of an elevation device. At this raised position, the middle portion of the cover sheet K mounted on the pressing member 83 is pressed and bonded to the pasted surface of a bundle of sheets Sa (refer to FIG. 9).

An alignment device 90 and an ejection belt 101 of the booklet ejection unit 100 are arranged on the upper portion of the cover-sheet outfitting device 80. The alignment device 90 is provided with a pair of alignment plates movable and facing each other in the width direction of the cover sheet K. When the cover-sheet outfitting device 80 has stopped at the lowered position to introduce the cover sheet K, the alignment device 90 shifts from the initial position to press both sides of the cover sheet K before being trimmed, in the width direction, whereby widthwise alignment is performed. The cover sheet K having been subjected to widthwise alignment free from skew is switched back in the direction opposite to the direction of introduction. After being conveyed to the cover-sheet trimming device 70, the sheet cover K is trimmed at a predetermined position.

Before the cover sheet K having been trimmed is bonded to the spine portion of the bundle of sheets Sa at the lowered position of the cover-sheet outfitting device 80, the alignment device 90 again shifts from the initial position and presses both sides in the width direction of the cover sheet K to provide widthwise alignment. The cover sheet K is placed at a predetermined position. Then the alignment device 90 retracts, but the cover-sheet outfitting device 80 is raised while the cover sheet K is kept at a predetermined position where it has been placed. Thus, the alignment device 90 installed on the cover-sheet outfitting device, which can be raised and lowered, determines the position of the cover sheet in the width direction before and after the cover sheet K is trimmed by the cover-sheet trimming device 70, whereby the cover sheet trimming precision and the cover sheet outfitting precision are improved, and the structure is simplified. The bound booklet Sb having been produced by bonding the cover sheet K to the bundle of sheets Sa to be wrapping-folded for forming the front and back cover is ejected out of the apparatus by the ejection belt 101 arranged on the upper portion of the alignment device 90.

A cover-sheet folding unit is provided on the cover-sheet outfitting device 80. The cover-sheet folding unit has therein a pair of folding members 86 which are bilaterally symmetrical. The folding members 86 can come in contact with and separate from cover sheet K in the thickness direction of the sheet bundle Sa. The folding members 86 fold the cover sheet K along a side edge of the adhesive-coated surface of the sheet bundle Sa, and superposes a front cover sheet and a back cover sheet respectively on the front and the back of the sheet bundle Sa.

Upon completion of the step of folding the cover sheet K, the cover-sheet outfitting device 80 is lowered by the downward drive of the belt 85 and is moved to a retracted position. Then the ejection belt 101 having retracted outside in the width direction of the cover sheet K, together with the retreat of the alignment device 90, moves to the inside of the booklet Sb in the width direction below the booklet Sb and stops there. After that, when the grip of the holding device 41 has been released, the booklet Sb moves downward, and is stopped at the position where the spine portion of lower part of the booklet Sb comes in contact with the upper surface of the ejection belt 101.

The booklet Sb for which the cover sheet K is bonded to the adhesive-coated spine portion which is an edge (opposite side of the fore edge) of the sheet bundle Sa and a front cover, a back cover and a spine cover are formed is ejected out of the apparatus from an ejection outlet 102 to an exterior sheet ejection apparatus C by the ejection belt 101 of the booklet ejection unit 100. The booklets Sb having been ejected by the ejection belt 101 are sequentially placed on the elevation type sheet ejection stand 103 of the sheet ejection apparatus C shown in FIG. 1. When the booklets Sb have been ejected and placed on the elevation type sheet ejection stand 103, the elevation type sheet ejection stand 103 is lowered gradually by the rotating wire 104. When the elevation type sheet ejection stand 103 has reached the bottom end, the booklet Sb is transferred to the conveyance belt 105 and is ejected out of the apparatus by the rotating drive of the conveyance belt 105.

The bookbinding apparatus B is provided with a bookbinding apparatus control device 9C and a bookbinding apparatus warning device 9D. In response to the detection by an adhesive deterioration detecting device (to be described later), the bookbinding apparatus control device 9C allows the bookbinding apparatus warning device 9D to display a warning to indicate the deterioration of adhesive. The bookbinding apparatus control device 9C is electrically connected with the control device 9A of the image forming apparatus A. The information on the result of detection by the adhesive deterioration detecting device is transmitted immediately to the control device 9A.

In the present embodiment, the bookbinding apparatus B is equipped with a bookbinding apparatus control device 9C and a bookbinding apparatus warning device 9D. However, when the bookbinding apparatus B is used as an image forming system, the bookbinding apparatus control device 9C and bookbinding apparatus warning device 9D of the bookbinding apparatus B are not necessary. To be more specific, because the image forming apparatus A is equipped with a control device 9A and operation section 9B, it is capable of serving the functions of the bookbinding apparatus control device 9C and bookbinding apparatus warning device 9D of the bookbinding apparatus B.

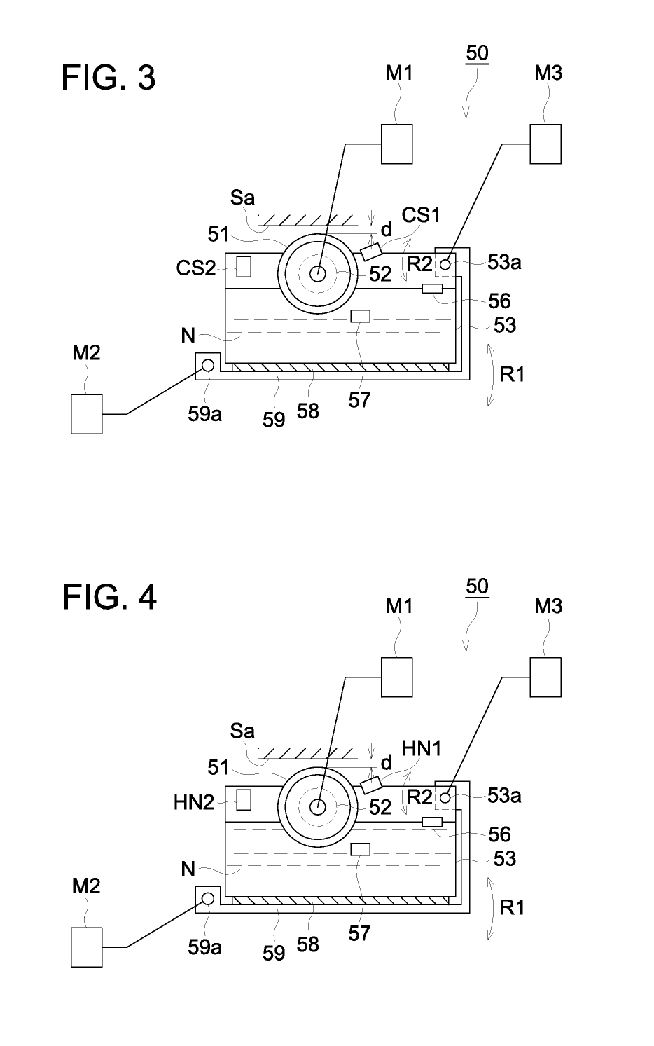

FIG. 3 is a schematic cross sectional view showing the structure and operation in the first embodiment of the adhesive coating device 50 of the present invention.

The adhesive coating device 50 includes an adhesive coating roller 51, rotating device 52, adhesive container 53, liquid level sensor 56, liquid temperature sensor 57, heater 58, movable platen 59, adhesive coating roller drive motor M1, platen swinging motor M2, adhesive container swinging motor M3, and color sensors CS1 and CS2. The adhesive container 53 as an adhesive reservoir containing the adhesive N incorporates an adhesive coating roller 51 as an adhesive coating member, a liquid level sensor 56 for detecting the level of the liquid surface (top surface) of the adhesive N, and a liquid temperature sensor 57 for detecting the temperature of the adhesive N. Further, the lower surface of the adhesive container 53 is provided with a heater 58 as a heating member for heating the adhesive N. A color sensor CS1 as an adhesive deterioration detecting device is installed at the position above and opposed to the adhesive coating roller 51, and a color sensor CS2 is installed above the liquid level of the adhesive container 53. Further, a movable platen 59 made of an L-shaped tabular member for holding the adhesive container 53 so as to allow free swinging is installed below the heater 58. A swinging rotary shaft 59a is connected integrally with the movable platen 59 in the vicinity of one side of the bottom surface (rectangular) of the movable platen 59, which is parallel to the rotary shaft (without reference numeral) of the adhesive coating roller 51. The swinging rotary shaft 59a is held rotatably by the bearing member (not illustrated) fixed onto the frame of the bookbinding apparatus B. The movable platen 59 is held in such a way as to swing around the swinging rotary shaft 59a in the direction of the arrow R1. The swinging rotary shaft 59a is connected with the connecting device consisting of a gear and others (not illustrated) and is linked with the platen swinging motor M2 through this connecting device.

Similarly, a swinging rotary shaft 53a connected integrally with the adhesive container 53 is installed close to one edge of the four edges on the upper portion of the adhesive container 53, which is parallel to the swinging rotary shaft 59a, at the position set apart farthest from the swinging rotary shaft 59a. This swinging rotary shaft 53a is fitted into a hole (without reference numeral) formed in an upper part of the L-shaped rising portion of the movable platen 59. Thus, the adhesive container 53 is held in such a way as to be freely swung around the swinging rotary shaft 53a in the direction of arrow R2 with respect to the movable platen 59. The swinging rotary shaft 53a is connected with the connecting device consisting of a gear and others (not illustrated) and is linked with the adhesive container swinging motor M3 through this connecting device.

The amount of adhesive N coated on the spine portion (the surface opposed to the illustrated adhesive coating roller 51) of the sheet bundle Sa changes according to the distance “d” between the sheet bundle Sa (spine portion) and adhesive coating roller 51. To change this distance “d”, the movable platen 59 whose rotating center is the swinging rotary shaft 59a is swung and the adhesive container 53 whose rotating center is the swinging rotary shaft 53a is swung. This changes the distance “d” between the sheet bundle Sa and adhesive coating roller 51. Dual swinging of the movable platen 59 and adhesive container 53 is intended to maintain the horizontality of the adhesive container 53 when the distance “d” has been changed. In the present embodiment, a satisfactory result is obtained by setting the aforementioned distance “d” at 1.6 through 2.4 mm.

The connecting devices linked to the platen swinging motor M2 and adhesive container swinging motor M3 are provided with encoders (not illustrated). The amounts of rotation of the two motors M2 and M3 are controlled by the control device 9A, so that the distance “d” can be adjusted.

To be more specific, by changing two swing angles of the movable platen 59 and adhesive container 53 as corresponding reference values in conformity to the preset contrastive data, the distance “d” between the sheet bundle Sa (spine portion) and adhesive coating roller 51 can be set at a desired value with the adhesive container 53 kept horizontal at all times. A proper value for the distance “d” between the sheet bundle Sa and adhesive coating roller 51 is provided in advance by experimentation, in conformity to the thickness of the sheet bundle Sa, the thickness of the cover sheet K and quality of the material thereof. The contrastive data thereof is stored as a program in the memory built in the control device 9A. Thus, when information on the thickness of the sheet bundle Sa, the thickness of the cover sheet K and quality of the material thereof has been inputted into the operation section 913 of the image forming apparatus A, the control device 9A calculates the distance “d” from the program to driven the platen swinging motor M2 and adhesive container swinging motor M3 so that the distance “d” is set to a proper value.

In the meantime, the rotary shaft (without reference numeral) of the adhesive coating roller 51 is linked with the adhesive coating roller drive motor M1 as a drive source for driving the adhesive coating roller 51, through the rotating device 52 as a power transmission device including a gear. The adhesive coating roller drive motor M1 is a speed-adjustable reversible motor. To control the amount of the adhesive N deposited on the adhesive coating roller 51, the speed and direction of rotation can be changed in conformity to the instruction from the control device 9A.

Upon receipt of the information on the top level of the adhesive from the liquid level sensor 56, the control device 9A controls the operation of the adhesive supply device (not illustrated) to ensure that the top level (height) of the adhesive in the adhesive container 53 is kept within a prescribed range at all times. Further, upon receipt of the information on the temperature of the adhesive in the adhesive container 53 from the liquid temperature sensor 57, the control device 9A controls the operation of the heater 58 to maintain the temperature of the adhesive in the adhesive container 53 within a prescribed range.

The color sensor CS1 as an embodiment of the present invention is installed opposed to the adhesive coating roller 51, and serves to detect the color of the adhesive N deposited on the surface of the adhesive coating roller 51. The color sensor CS2 is installed at a position above and opposed to the liquid level of the adhesive N of the adhesive container 53, and serves to detect the color of the adhesive N in the adhesive container 53.

A solid pellet-like hot-melt adhesive is used as an adhesive N in the present embodiment, and is liquefied by being heated to a melted state by the heater 58 installed on the lower portion of the adhesive container 53.

The following describes the operation of coating the adhesive by the adhesive coating device 50 in the first embodiment.

When bookbinding instruction and sheet information have been set from the operation section 9B of the image forming apparatus A, the control device 9A turns on the heater 58 of the adhesive container 53 through the bookbinding apparatus control device 9C of the bookbinding apparatus B in synchronization with the formation of the sheet bundle Sa in the sheet bundle loading unit 30. From the information on the size, thickness and number of the sheets S and the information on the thickness of the cover sheet K, the length of the cover sheet K to be trimmed is calculated, as described above, and is stored in the memory of the control device 9A.

The on-off control of the heater 58 is started when the temperature of the adhesive N detected by the liquid temperature sensor 57 in the adhesive container 53 has reached the preset reference temperature. The on-off operation is performed in conformity to the temperature detected by the liquid temperature sensor 57. When the temperature of the adhesive N has reached the preset reference temperature, the adhesive coating roller drive motor M1 is driven to rotate the adhesive coating roller 51 and the heater 58 is then turned off The adhesive coating roller 51 also has a function of the agitating member. The adhesive N in the adhesive container 53 is agitated by the rotation of the adhesive coating roller 51, and is uniformly melted. After that, the liquid temperature in the adhesive container is reduced. When the temperature detected by the liquid temperature sensor 57 has been reduced below the reference temperature, the heater 58 is again turned on. The liquid temperature in the adhesive container 53 is maintained constant by the repetition of this temperature control.

When the liquid temperature in the adhesive container 53 has reached the reference temperature and the sheet bundle Sa held by the holding device 41 has reached a prescribed position for adhesive coating, the movable member 54 starts reciprocal motion, and the adhesive N deposited on the surface of the rotating adhesive coating roller 51 is applied on the spine position of the sheet bundle Sa.

The adhesive N in the adhesive container 53 is consumed with the progress of the operation of coating the sheet bundle Sa. The liquid level is detected by the liquid level sensor 56. A new adhesive N is supplied from an adhesive storage tank (not illustrated) by an adhesive supply device (not illustrated) to ensure that the top level (height) of the adhesive N is kept constant at all times.

The color of the adhesive N as a result of detection by the color sensors CS1 and CS2 is compared with the color (a reference color for brown or orange, hereinafter referred to as “the reference color”) as a reference set based on experimentation. The reference color is stored in the memory of the control device 9A. If the density of the detected color is higher than that of the reference color, the control device 9A allows a warning to be displayed. The warning is given by the lighting up or flashing of the warning lamp or by display of a warning on the display section installed on the operation section 9B or bookbinding apparatus warning device 9D. In the present embodiment, the reference color is determined by the color sample of the standard of the manufacturer. Further, though according to the above example, density is compared, the hue can be detected and compared instead.

In the present embodiment, the control device 9A allows the operation section 9B or bookbinding apparatus warning device 9D to display a warning. It is also possible to adopt such a structure that the bookbinding apparatus B is provided with the modes of consuming, discarding and replacing the adhesive in the adhesive coating device 50 automatically, and the control device 9A selects any one of these modes.

According to the first embodiment of the present invention, the state of deterioration of the adhesive N can be determined by the color of the adhesive N. This prevents the color from being transferred to the spine cover sheet.

FIG. 4 is a schematic cross sectional view showing the structure and operation in the second embodiment of the adhesive coating device 50 of the present invention.

The second embodiment of the adhesive coating device 50 is similar to the first embodiment. The same reference numerals will be assigned to the members having the same functions and the members will not be described to avoid duplication. Only the structural differences will be described below.

The difference of the second embodiment from the first embodiment is found in the method of detecting the state of deterioration of the adhesive N. To be more specific, in the first embodiment, the state of deterioration of the adhesive N is detected through the detection of the color of the adhesive N by the color sensors CS1 and CS2. In the second embodiment, however, the state of deterioration of the adhesive N is detected through the detection of the reflectivity of the adhesive N by the reflection densitometers HN1 and HN2 as adhesive deterioration detecting devices.

In the second embodiment, the reflectivity of the adhesive N deposited on the surface of the adhesive coating roller 51 or the adhesive N stored in the adhesive container 53 is detected by the reflection densitometers HN1 and HN2. The reflectivity of the adhesive N as a result of detection by the reflection densitometers HN1 and HN2 is compared with the reflectivity (hereinafter referred to as “reference reflectivity”) as a reference preset based on experimentation, and the control device 9A allows a warning to be displaced if the detected reflectivity is lower than the reference reflectivity. Similarly to the case of the first embodiment, the warning is given by the lighting up or flashing of the warning lamp or by display of a warning on the display section installed on the operation section 9B or bookbinding apparatus waning device 9D. In the present embodiment, the threshold value of the reference reflectivity is ten percent. If this value cannot be reached, the adhesive is assumed to have degraded, and a warning is displayed.

According to the second embodiment of the present invention, the state of deterioration of the adhesive N can be determined by the reflectivity of the adhesive N, which can be easily detected by a regular reflection densitometer.

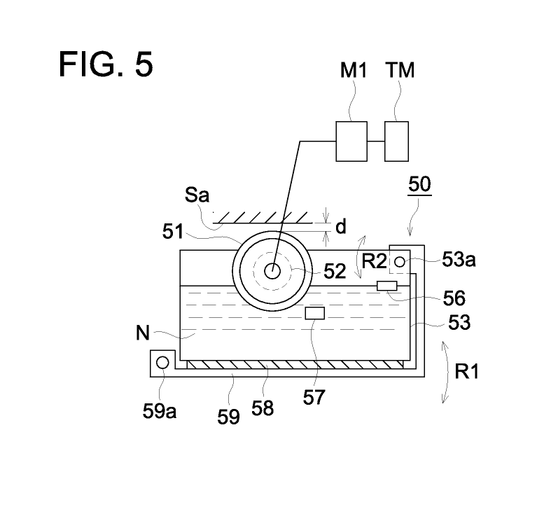

FIG. 5 is a schematic cross sectional view showing the structure and operation in the third embodiment of the adhesive coating device 50 of the present invention.

The third embodiment of the adhesive coating device 50 is similar to the first embodiment. The same reference numerals will be assigned to the members having the same functions and the members will not be described to avoid duplication. Only the structural differences will be described below. The difference of the third embodiment from the first embodiment is found in the method of detecting the state of deterioration of the adhesive N. To be more specific, in the first embodiment, the state of deterioration of the adhesive N is detected through the detection of the color of the adhesive N by the color sensors CS1 and CS2. In the third embodiment, however, the state of deterioration of the adhesive N is detected through the detection of the adhesive viscosity in the adhesive container 53 by the adhesive viscosity detecting device as an adhesive deterioration detecting device. The adhesive viscosity in the third embodiment is calculated from the torque as the load of the adhesive coating roller drive motor M1 that is a drive source for driving to rotate the adhesive coating roller 51.

The adhesive viscosity detecting device includes an adhesive coating roller 51 as an agitating member for agitating the adhesive N in the adhesive container 53, an adhesive coating roller drive motor M1 as a source of driving the adhesive coating roller 51, and a torque meter TM as a load measuring device of the adhesive coating roller drive motor M1.

Regarding the viscosity of the adhesive N in the adhesive container 53, the torque of the rotary shaft of the adhesive coating roller 51 is first measured by the torque meter TM as a load measuring device which is connected to the rotary shaft. The viscosity is calculated from the torque having been measured. To calculate the viscosity of the adhesive N, the contrastive data of the viscosity of the adhesive N and the torque of the rotary shaft of the adhesive coating roller 51 is created in advance by experimentation. This data is stored as a program in the memory of the control device 9A. A torque as a reference (hereinafter referred to as “reference torque”) is preset as a standard for determination of the deterioration state of the adhesive N, and the torque value measured by the torque meter TM is compared with the reference torque. If the measured torque as a result of detection is smaller than the reference torque, the control device 9A determines that the adhesive N is degraded, and allows a warning to be displayed. Similarly to the case of the first embodiment, the warning is given by the lighting up or flashing of the warning lamp or by display of a warning on the display section installed on the operation section 9B or bookbinding apparatus warning device 9D. Conversely, if the measured torque as a result of detection is greater than the reference torque (if softening of the adhesive N is insufficient after heating by the heater 58), the control device 9A determines that the adhesive N is degraded, and allows a warning to be displayed. In the present embodiment, when the viscosity of the adhesive N in the adhesive container 53 is less than 1000 mPa·s or more than 2000 mPa·s, the adhesive is determined to have been degraded, and warning is displayed.

According to the third embodiment of the present invention, the state of the deterioration of adhesive N can be determined from the viscosity of the adhesive N. This ensures earlier detection of the state of the deterioration of adhesive N, and prevents the operation failure or trouble of the agitation mechanism from being caused by solidification of the adhesive. In the third embodiment, the adhesive coating roller 51 is used as an agitating member, and the load of the drive source of the adhesive coating roller 51 is measured to determine the state of deterioration. Without the present invention being restricted thereto, it is possible to adopt a structure in which, separately from the adhesive coating roller 51, an agitating member for agitating the adhesive in the adhesive container 53 is installed, and the load of the drive source of this agitating member is measured so that the state of the deterioration is determined.

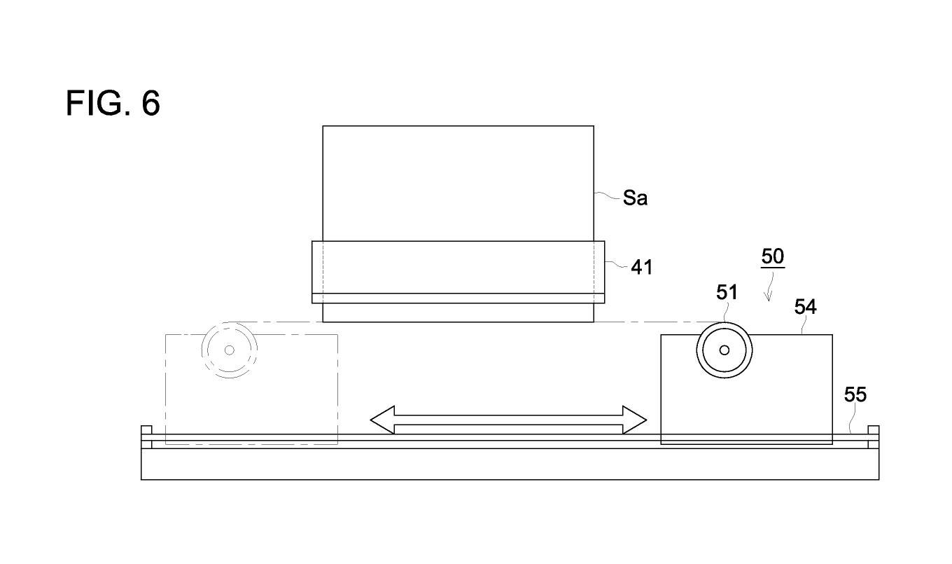

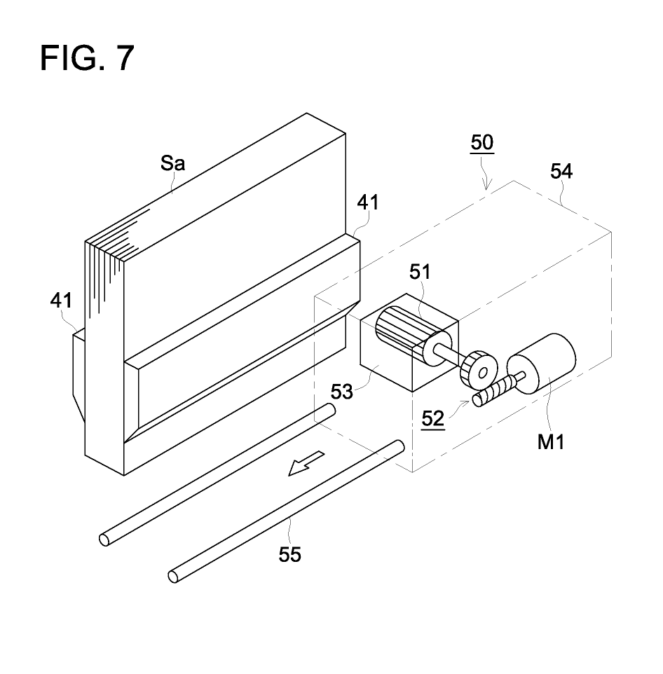

FIG. 6 is a schematic side view showing the positional relationship between the adhesive coating device 50 and holding device 41, and the operation thereof. FIG. 7 is a perspective view of FIG. 6.

The movable member 54 of the adhesive coating device 50 is moved by an unillustrated driving unit in the direction that is in parallel with the longitudinal direction of a bottom surface of the sheet bundle Sa held by the holding member 41 in an upright position. The movable member 54 starts moving from the initial position, on the rear side of the bookbinding apparatus B, and is moved along a guide member 55 to stop at a prescribed position on the front surface side of the bookbinding apparatus B, and returns to the initial position after being driven to be reversed. The sheet bundle Sa is coated with adhesive by the adhesive coating device 50 from the start of the movable member 54 in the reciprocal motion at the initial position to its arrival at a prescribed position. A speed-adjustable reversible motor (not illustrated) is preferably used as a drive device for moving the movable member 54. The motor is connected with the movable member 54 by the conventionally known wire, belt and pulley, or rack-pinion assembly which changes the rotary motion into a linear motion.

In the adhesive coating device 50, the adhesive coating roller 51 dipped in the adhesive N stored in the adhesive container 53 is rotated by the adhesive coating roller drive motor M1 and rotating device 52. A layer of the adhesive N in the adhesive container 53 is formed on the surface of the adhesive coating roller 51. While the movable member 54 is driven by the drive device to perform a one way motion or a reciprocating motion from the initial position to a prescribed position, adhesive is applied from the adhesive coating roller 51 on the lower surface of the sheet bundle Sa held in the upright position in the longitudinal direction.

FIG. 8 is a perspective view showing the elevation drive structure and operation of the holding device 41.

The supporting plate 42 of the holding device 41 for holding the sheet bundle Sa is supported by two belts 43A arranged on the front side F and two belts 43B arranged on the rear side R. The belt 43A is driven by the motor M5 of the third drive device and the front side F of the supporting plate 42 is moved in the vertical direction. The belt 43B is driven by the fourth drive device and the rear side R of the supporting plate 42 is moved in the vertical direction.

A first sensor (not illustrated) for detecting the stop position of the holding device 41 is arranged in the vicinity of the booklet bottom side L of the sheet bundle Sa, on the front side F of the supporting plate 42. This sensor detects the upper limit position of the rising cover-sheet outfitting device 80 on the booklet bottom side. After a prescribed number of pulses after the first sensor has detected the arrival of the cover-sheet outfitting device 80 at the upper limit position, the operation of the motor M5 is suspended. Further, a second sensor (not illustrated) for detecting the top position of the holding device 41 is located in the vicinity of the booklet top side U of the sheet bundle Sa on the rear side R of the supporting plate 42. This sensor detects the upper limit position of the rising cover-sheet outfitting device 80 on the booklet top side. After a prescribed number of pulses after the arrival of the cover-sheet outfitting device 80 at the upper limit position has been detected by the second sensor, the operation of the motor M6 is suspended.

The motor M5 and motor M6 are driven almost simultaneously. The cover sheet K placed on the cover-sheet outfitting device 80 and the adhesive coated surface of the sheet bundle Sa held by the holding device 41 are bonded with each other in parallel relatively. To be more specific, the front side F and rear side R of the supporting plate 42 are separately driven in the vertical direction. This ensures that the booklet bottom side L and the booklet top side U of the spine portion of the sheet bundle Sa held by the holding device 41 arranged on the supporting plate 42 is pressed against the cover sheet K placed on the movable casing 84 uniformly.

FIG. 9 is a schematic sectional view of the bookbinding apparatus 13 for description of a structure and movement for bonding the cover sheet K to the sheet bundle Sa.

When the belt 85 is operated by an unillustrated driving unit after completion of a process to apply adhesive paste on the sheet bundle Sa, the movable easing 84 is moved to the raised position. In this raised position, a central portion of the cover K placed on the pressing member 83 is brought into contact with an adhesive-coated surface of the sheet bundle Sa to be pressed and stuck thereon. In the raised position, the holding device 41 having the sheet bundle Sa held pushes down the sheet bundle Sa keeping in contact with the pressure member 83. A pair of folding members 86 on the right and left are moved in the directions to sandwich the sheet bundle Sa. This allows the cover sheet K to be folded (to be described later).

Incidentally, the ejection belt 101 is retreated in advance of the ascent of the cover-sheet outfitting device 80, so that interference of the ejection belt with the sheet bundle Sa held in the upright position is prevented.

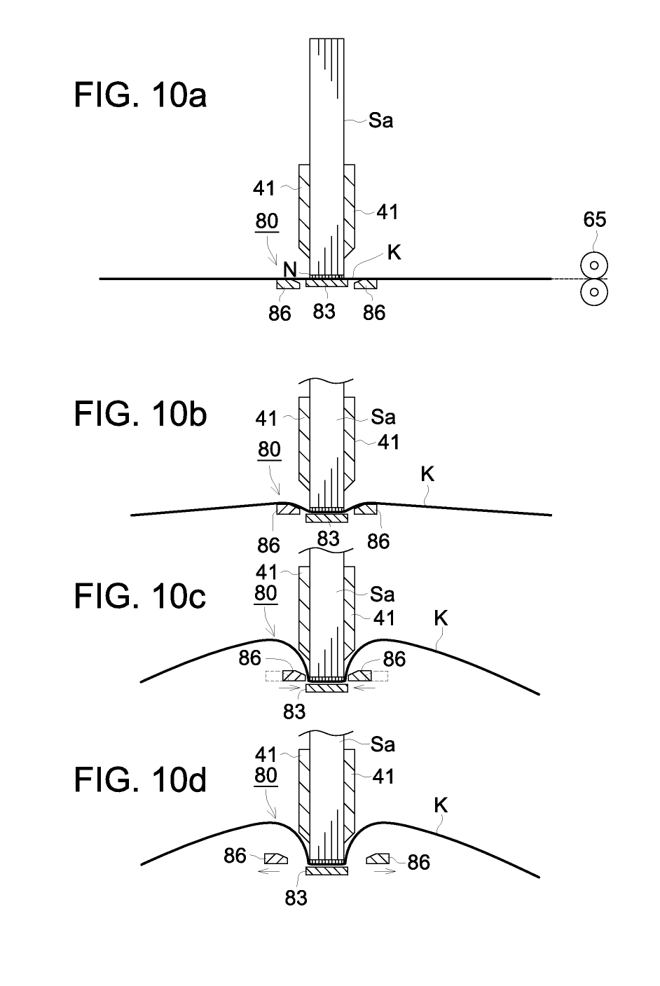

Each of FIGS. 10(a)-10(d) is a sectional view of the cover-sheet outfitting device 80 and the sheet bundle Sa showing each process of folding the cover sheet K, and FIG. 10(a) shows a start of folding of a cover sheet, FIG. 10(b) shows the middle of folding of a cover sheet, FIG. 10(c) shows an end of folding of a cover sheet and FIG. 10(d) shows release of cover sheet folding pressure, respectively. The holding device 41 pushes down the sheet bundle Sa while the holding device 41 is holding the sheet bundle Sa and the sheet bundle Sa is kept in contact with the pressure member 83, and because the pair of folding members 86 on the right and left sides move so as to sandwich the sheet bundle Sa, the folding of the cover sheet K is carried out.

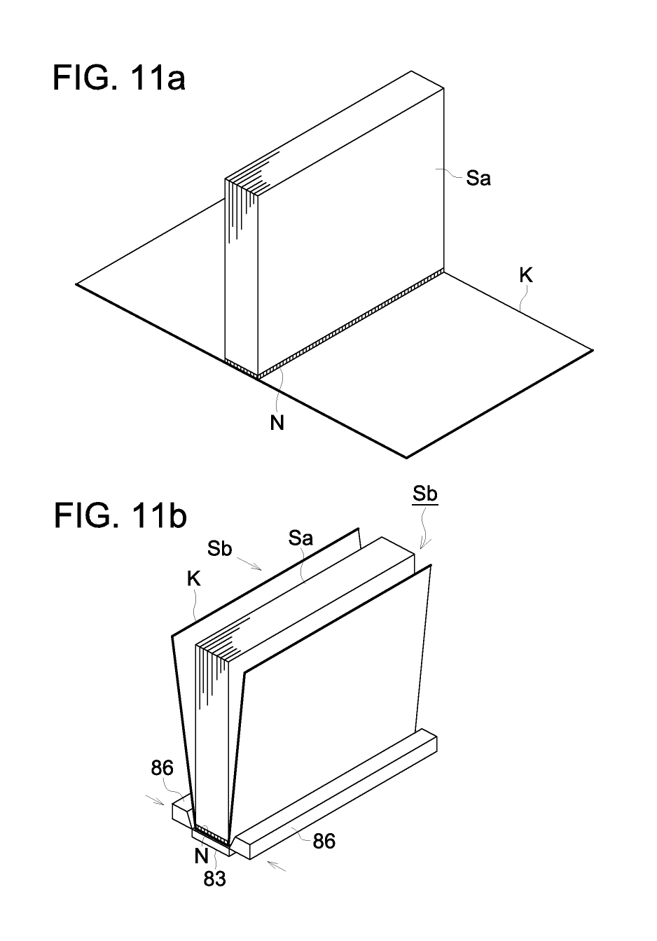

Each of FIGS. 11(a) and 11(b) is a perspective view of the sheet bundle Sa on which the cover sheet K is pasted and the booklet Sb that is made by applying wrapping-folding to the cover sheet K on the sheet bundle Sa. FIG. 11(a) is a perspective view of the sheet bundle Sa and FIG. 11(b) is a perspective view of the booklet Sb.

After the cover sheet K has been bonded to the sheet bundle Sa having adhesive attached thereto, a pair of folding members 86 are driven by a drive device (not illustrated) while the cover-sheet outfitting device 80 of FIG. 9 is located at the raised position. By the lowering motion of the holding device 41 holding the sheet bundle Sa, the cover sheet K is lowered in-between the pair of folding members 86, and is folded at the edge portion on the adhesive-coated surface of the sheet bundle Sa (see FIG. 11B). After that, the pair of folding members 86 move in the horizontal direction toward the adhesive-coated surface of the sheet bundle Sa and the surfaces on both sides of the sheet bundle Sa are pressed and shaped so that a booklet Sb is formed.

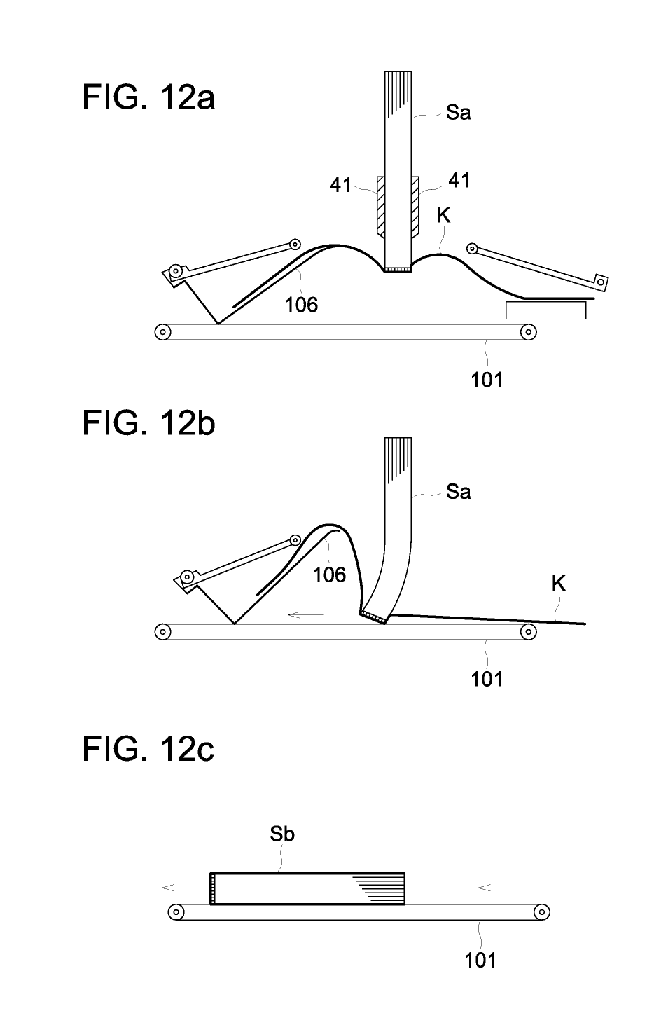

FIG. 12 is a front view showing an ejection process of the booklet Sb composed of the bundle of sheet Sa and the cover sheet K.

After the end of a folding process for the cover sheet K, a descent of the belt 85 makes the cover-sheet outfitting device 80 to descend. After the descent of the cover-sheet outfitting device 80 to retreat, the cover-sheet supporting member 106 is swung to lift up a part of the cover sheet K (see FIG. 12(a)).

Rotation of the ejection belt 101 is started by an unillustrated drive unit, and after the sheet bundle Sa bonded with the cover sheet K has descended, the lower end portion of it is moved toward the conveyance direction by the ejection belt 101 due to the contact with the ejection belt 101 (see FIG. 12(b)).

The booklet Sb made of the sheet bundle Sa bonded with the cover sheet K is laid on the turning ejection belt 101 and conveyed to be ejected from the apparatus (see FIG. 12(c)).

The bookbinding apparatus B in an embodiment of the present invention can be formed to be an independent apparatus such that the sheet bundle Sa processed and made by other image forming apparatuses may be loaded on the sheet bundle loading unit 30 and a booklet can be made by the wrapping bookbinding after an adhesive coating process and a cover sheet outfitting process.

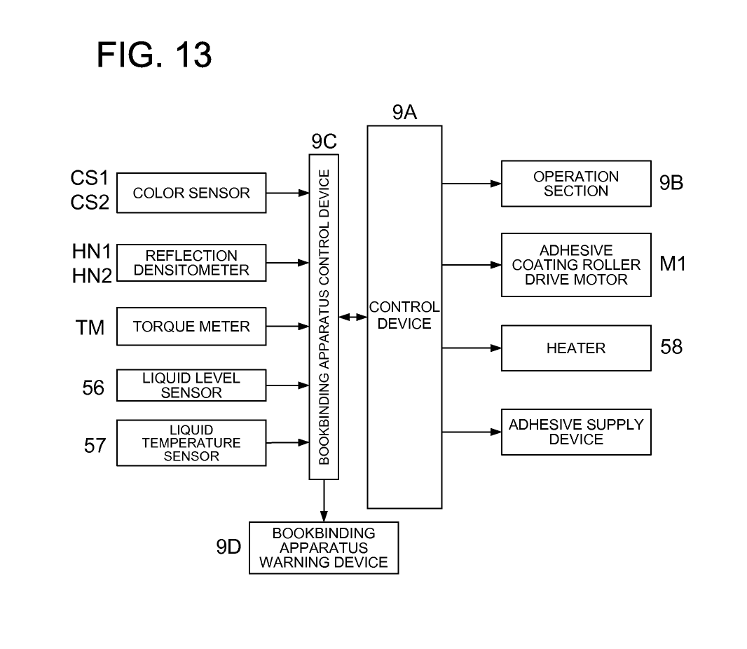

FIG. 13 is a block diagram showing the control system of the control device 9A for controlling the operation of the bookbinding apparatus B in an embodiment of the present invention.

The control device 9A receives input information from the color sensors CS1, CS2 and reflection densitometers HN1 and HN2 and torque meter TM as adhesive deterioration detecting devices, and the liquid level sensor 56, liquid temperature sensor 57 and others through the bookbinding apparatus control device 9C of the bookbinding apparatus B. Based on this information, the control device 9A controls the operations of various components such as the operation section 9B or bookbinding apparatus warning device 9D as a warning device, and the adhesive coating roller drive motor M1, heater 58, and adhesive supply device.

In the embodiment of the present invention, the function of the warning device is not restricted to the issuing of a warning by display. A warning can be given by sound or other means.

The embodiment of the present invention ensures earlier detection of the deterioration of adhesive, and prevents the problems on the bookbinding quality such as discoloration of the spine cover sheet or separation of the cover sheet due to the use of degraded adhesive.

What is claimed is:

1. A bookbinding apparatus comprising:
an adhesive reservoir for storing melted adhesive;
a heating member for heating and melting the adhesive stored in the adhesive reservoir;
an adhesive coating member for coating a sheet bundle with the adhesive stored in the adhesive reservoir; and
an adhesive deterioration detecting device for detecting a state of deterioration of the melted adhesive.

2. The bookbinding apparatus of claim 1, further comprising:
a warning device for issuing a warning based on a detection result of the adhesive deterioration detecting device; and
a control device for controlling operation of the adhesive deterioration detecting device and the warning device,
wherein the control device allows the warning device to issue a warning based on the detection result of the adhesive deterioration detecting device.

3. The bookbinding apparatus of claim 1,
wherein the adhesive deterioration detecting device is a color sensor for detecting color of the adhesive.

4. The bookbinding apparatus of claim 1,
wherein the adhesive deterioration detecting device is a reflection densitometer for detecting reflectivity of the adhesive.

5. The bookbinding apparatus of claim 1,
wherein the adhesive deterioration detecting device is a adhesive viscosity detecting device for detecting viscosity of the adhesive.

6. The bookbinding apparatus of claim 5,
wherein the adhesive viscosity detecting device comprises:
an agitating member for agitating the adhesive stored in the adhesive reservoir;
a drive source for driving the agitating member; and
a load measuring device for measuring a load of the drive source,
wherein the control device determines the state of deterioration of the adhesive based on the load of the drive source measured by the load measuring device.

7. The bookbinding apparatus of claim 6,
wherein the adhesive coating member is an adhesive coating roller which is configured to rotate and the adhesive coating roller has a function of the agitating member.

8. The bookbinding apparatus of claim 3,
wherein the color sensor includes a first color sensor facing the adhesive coating member and a second color sensor facing a surface of the adhesive stored in the adhesive reservoir.

9. The bookbinding apparatus of claim 4,
wherein the reflection densitometer includes a first reflection densitometer facing the adhesive coating member and a second reflection densitometer facing a surface of the adhesive stored in the adhesive reservoir.

10. The bookbinding apparatus of claim 3,
wherein the color sensor detects color density of the adhesive.

11. The bookbinding apparatus of claim 3,
wherein the color sensor detects hue of the adhesive.

12. An image forming system comprising:
an image forming apparatus for forming an image on a sheet; and
a bookbinding apparatus for bookbinding by applying adhesive on a bundle of sheets each of which has an image formed thereon by the image forming apparatus, the bookbinding apparatus comprising:
an adhesive reservoir for storing melted adhesive;
a heating member for heating and melting the adhesive stored in the adhesive reservoir,
an adhesive coating member for coating a sheet bundle with the adhesive stored in the adhesive reservoir; and
an adhesive deterioration detecting device for detecting a state of deterioration of the melted adhesive.

13. The image forming system of claim 12, further comprising:
a warning device for issuing a warning based on a detection result of the adhesive deterioration detecting device; and
a control device for controlling operation of the adhesive deterioration detecting device and the warning device,
wherein the control device allows the warning device to issue a warning based on the detection result of the adhesive deterioration detecting device.

14. The image forming system of claim 12,
wherein the adhesive deterioration detecting device is a color sensor for detecting color of the adhesive.

15. The image forming system of claim 12,
wherein the adhesive deterioration detecting device is a reflection densitometer for detecting reflectivity of the adhesive.

16. The image forming system of claim 12,
wherein the adhesive deterioration detecting device is a adhesive viscosity detecting device for detecting viscosity of the adhesive.

17. The image forming system of claim 16,
wherein the adhesive viscosity detecting device comprises:
an agitating member for agitating the adhesive stored in the adhesive reservoir,
a drive source for driving the agitating member; and
a load measuring device for measuring a load of the drive source,
wherein the control device determines the state of deterioration of the adhesive based on the load of the drive source measured by the load measuring device.

18. The image forming system of claim 17,
wherein the adhesive coating member is an adhesive coating roller which is configured to rotate and the adhesive coating roller has a function of the agitating member.

19. The image forming system of claim 14,
wherein the color sensor includes a first color sensor facing the adhesive coating member and a second color sensor facing a surface of the adhesive stored in the adhesive reservoir.

20. The image forming system of claim 15,
wherein the reflection densitometer includes a first reflection densitometer facing the adhesive coating member and a second reflection densitometer facing a surface of the adhesive stored in the adhesive reservoir.
